(19) United States
(12) Patent Application Publication
(10) Pub. No.: US 2025/0126081 A1
(43) Pub. Date: Apr. 17, 2025

(54) DIALOG CONTROL FLOW FOR INFORMATION RETRIEVAL APPLICATIONS

(71) Applicant: FMR LLC, Boston, MA (US)

(72) Inventors: Allen Detmer, Patriot, IN (US); Brian Christopher Mansfield, Milford, OH (US)

(21) Appl. No.: 18/907,765

(22) Filed: Oct. 7, 2024

Related U.S. Application Data
(60) Provisional application No. 63/544,101, filed on Oct. 13, 2023.

(51) Int. Cl. H04L 51/02; G06F 40/35; G10L 15/183; G10L 15/22

(52) U.S. Cl. CPC H04L 51/02; G06F 40/35; G10L 15/183; G10L 15/22

(57) ABSTRACT

Methods and apparatuses are described for dialog control flow in information retrieval applications. A server establishes a chat-based communication session between an information retrieval application and a client device. The server determines a user intent from utterances received from a user of the client device and initiates a first dialog workflow associated with the user intent. The server invokes NLP services using the utterances to determine a comprehension score for the user intent and identifies a first one of the NLP services to continue the first dialog workflow when the comprehension score is at or above a threshold value, including generating a response to the utterances using the first NLP service. The server delegates the communication session to a second dialog workflow when the comprehension score is below the threshold value, including invoking a generalized language processing service associated with the second dialog workflow using the user intent to generate a response to the utterances. The server transmits the generated response to the client device as part of the chat-based communication session.

### RELATED APPLICATION(S)

This application claims priority to U.S. Provisional Patent Application No. 63/544,101, filed on Oct. 13, 2023, the entirety of which is incorporated herein by reference.

### TECHNICAL FIELD

This application relates generally to methods and apparatuses, including computer program products, for dialog control flow for information retrieval applications, including but not limited to conversation service applications such as virtual assistants and chatbots.

### BACKGROUND

As computing technology has become commonplace, many users have abandoned the use of live telephone conversations with service agents and representatives to answer questions and resolve issues, in favor of electronic communications such as text-based online chat sessions over the Internet involving the use of computing devices and related chat-based software. To efficiently manage this form of communication, many organizations are turning to automated information retrieval applications, such as conversation service software applications (virtual assistants (VAs), chatbots) or intelligent search interfaces, to interact with end users using advanced language processing and data interpretation technology. One such technology is the use of a natural language processing (NLP) service that interprets messages coming from an end user in order to determine the user's intent, so that the information retrieval software can respond in a way that meets the end user's needs or goals. Many times, an intelligent information retrieval software application can resolve the end user's inquiry quickly and efficiently, which reduces cost for the organization and increases satisfaction of the end user.

A deficiency of existing information retrieval software applications, particularly conversation service applications, lies in the fact that, e.g., a VA or chatbot is directly mapped with one NLP service for determining the response(s) to the end user's messages. This one-to-one mapping restricts the flexibility and responsiveness of the conversation service application in terms of providing more pertinent answers to end user inquiries and richer interaction experiences for the end user.

Also, conversation service applications often rely on an existing knowledge base to respond to user inquiries and improve response time. For example, the knowledge base may contain answers to frequently-asked questions, such that when a user asks a question that has previously been answered, the conversation service application can retrieve information directly from the knowledge base to prepare a response to the user—instead of issuing a new query to a data provider or other source of information. However, the conversation service application may not be able to rely on an existing knowledge base for questions that are new or have not previously been answered. If the conversation service application attempts to retrieve responsive information from the knowledge base in this scenario, it may be inaccurate and/or incomplete

Some conversation service applications utilize large language models (LLMs) to generate dynamic responses to newly-seen customer inquiries. Generally, the conversation service application generates a prompt from the user input and executes an LLM using the prompt to create the response. However, LLMs are typically trained on a historical dataset that is limited to the period before their training cut-off. For queries involving post-training data, LLMs alone may not suffice for accurate issue resolution. Enhancing LLM accuracy necessitates periodic retraining with updated or new content, which can be both expensive and time intensive. If LLMs lack training on the latest data, it becomes difficult for the conversation service application to provide relevant information to the end user.

### SUMMARY

Therefore, what is needed are methods and systems that provide for dynamic and adaptive control of dialog flows in information retrieval communication sessions, as well as augmentation of the information used for LLM prompts during the conversation dialog workflow to improve the relevance of corresponding LLM responses. The techniques described herein advantageously provide conversation experience owners more control over the flow of a conversation dialog workflow—thereby greatly improving the overall experience for the end user. In addition, the methods and systems allow for collection of context data prior to user intent classification and enable the information retrieval application to make intelligent decisions on model execution. Furthermore, the techniques beneficially enable the information retrieval application to leverage pre-trained LLMs during a conversation with an end user, while also dynamically enhancing the data provided to and analyzed by the LLMs to elicit a more accurate response.

The invention, in one aspect, features a computer system for dialog control flow in information retrieval software applications. The system includes a server computing device having a memory that stores computer-executable instructions and a processor that executes the computer-executable instructions. The server computing device establishes a chat-based communication session between an information retrieval software application of the server computing device and a client computing device. The server computing device determines a user intent from one or more utterances received from a user of the client computing device during the chat-based communication session. The server computing device initiates a first dialog workflow associated with the user intent. The server computing device invokes one or more natural language processing (NLP) services using the one or more utterances as input to determine a comprehension score for the user intent at each of the one or more NLP services. The server computing device identifies a first one of the NLP services to continue the first dialog workflow when the comprehension score for the identified NLP service is at or above a threshold value, including generating a response to the one or more utterances using the first NLP service. The server computing device delegates the chat-based communication session to a second dialog workflow when the comprehension score for each of the NLP services is below the threshold value, including invoking a generalized language processing service associated with the second dialog workflow using the user intent as input to generate a response to the one or more utterances. The server computing device transmits the generated response to the client computing device as part of the chat-based communication session.

The invention, in another aspect, features a computerized method of dialog control flow in information retrieval software applications. A server computing device establishes a chat-based communication session between an information retrieval software application of the server computing device and a client computing device. The server computing device determines a user intent from one or more utterances received from a user of the client computing device during the chat-based communication session. The server computing device initiates a first dialog workflow associated with the user intent. The server computing device invokes one or more natural language processing (NLP) services using the one or more utterances as input to determine a comprehension score for the user intent at each of the one or more NLP services. The server computing device identifies a first one of the NLP services to continue the first dialog workflow when the comprehension score for the identified NLP service is at or above a threshold value, including generating a response to the one or more utterances using the first NLP service. The server computing device delegates the chat-based communication session to a second dialog workflow when the comprehension score for each of the NLP services is below the threshold value, including invoking a generalized language processing service associated with the second dialog workflow using the user intent as input to generate a response to the one or more utterances. The server computing device transmits the generated response to the client computing device as part of the chat-based communication session.

Any of the above aspects can include one or more of the following features. In some embodiments, determining the user intent from one or more utterances comprises invoking one or more machine learning classification models using the one or more utterances as input to classify the one or more utterances as belonging to a defined user intent. In some embodiments, invoking one or more machine learning classification models using the one or more utterances as input comprises analyzing each of the one or more utterances, identifying one or more keywords in each utterance, and classifying each utterance as belonging to a defined user intent based upon the identified keywords for the utterance.

In some embodiments, the server computing device captures context information associated with one or more of the client computing device or the user of the client computing device when establishing the chat-based communication session. In some embodiments, initiating the first dialog workflow associated with the user intent comprises analyzing the context information in conjunction with the user intent to identify the first dialog workflow.

In some embodiments, the generalized language processing service associated with the second dialog workflow comprises a large language model (LLM) service. In some embodiments, invoking the generalized language processing service associated with the second dialog workflow comprises generating an input prompt for the LLM service based on the user intent, augmenting the input prompt using information from one or more external data providers, and invoking the LLM service using the augmented input prompt as input to cause the LLM service to generate the response to the one or more utterances. In some embodiments, the information retrieval software application comprises a conversation service application or a virtual assistant application.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for dialog control flow in information retrieval applications.

FIG. 2 is a flow diagram of a computerized method of dialog control flow in information retrieval applications.

FIG. 3 is a diagram of an exemplary state model view for a dialog control flow module of a server computing device.

FIG. 4 is a diagram of an exemplary workflow for dialog branching by a dialog control flow module of a server computing device.

FIG. 5 is a diagram of an exemplary workflow for execution of multiple parallel states by a dialog control flow module of a server computing device.

FIG. 6 is a diagram of another exemplary workflow for execution of multiple parallel states by a dialog control flow module of a server computing device.

### DETAILED DESCRIPTION

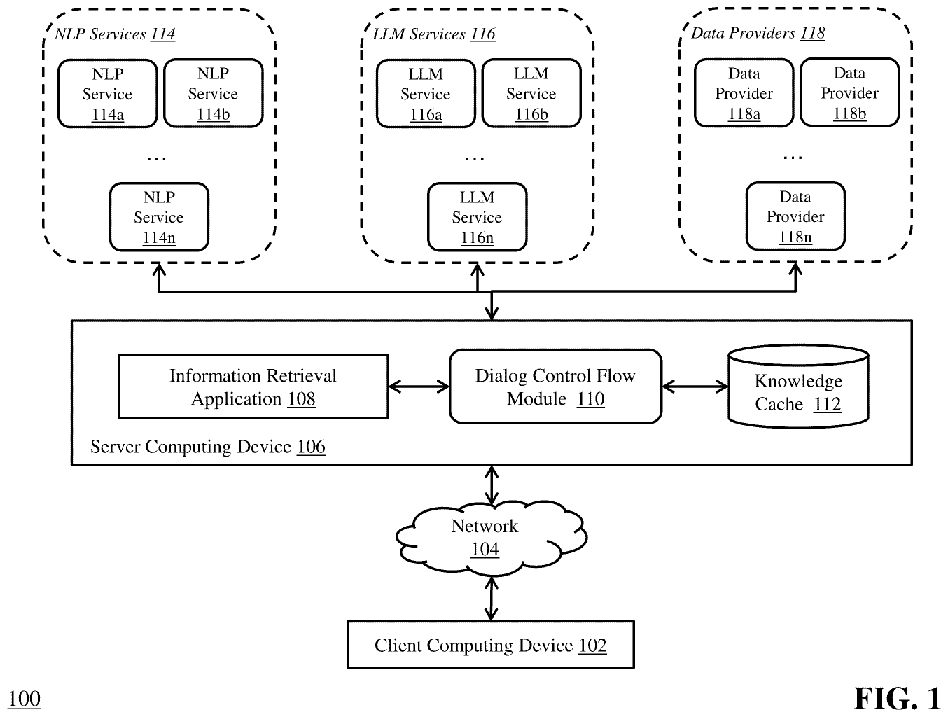

FIG. 1 is a block diagram of system 100 for dialog control flow in information retrieval applications. System 100 includes client computing device 102, communications network 104, server computing device 106 that includes information retrieval application 108, dialog control flow module 110, and knowledge cache 112, a plurality of NLP services 114a-114n, a plurality of large language model (LLM) services 116a-116n, and a plurality of data providers 118a-118n.

Client computing device 102 connects to one or more communications networks (e.g., network 104) in order to communicate with server computing device 106 to provide input and receive output relating to one or more chat-based communication sessions as described herein. Exemplary client computing devices 102 include but are not limited to desktop computers, laptop computers, tablets, mobile devices, smartphones, and the like. In some embodiments, system 100 can include another server computing device (not shown), such as a web server, which provides an interface between client computing device 102 and information retrieval application 108. It should be appreciated that other types of computing devices that are capable of connecting to the components of system 100 can be used without departing from the scope of the technology described herein. Although FIG. 1 depicts one client computing device 102, it should be appreciated that system 100 can include any number of client computing devices. In some embodiments, client computing device 102 is configured with chat application software, which enables remote computing device 102 to establish a chat-based communication session with the server computing device 106 via information retrieval application 108.

Communications network 104 enables client computing device 102 to communicate with computing device 106. Network 104 is typically comprised of one or more wide area networks, such as the Internet and/or a cellular network, and/or local area networks. In some embodiments, network 104 is comprised of several discrete networks and/or sub-networks (e.g., cellular to Internet).

Server computing device 106 is a device including specialized hardware and/or software modules that execute on a processor and interact with memory modules of server computing device 106, to receive data from other components of system 100, transmit data to other components of system 100, and perform functions for dialog control flow in information retrieval applications as described herein. Server computing device 106 includes information retrieval application 108, dialog control flow module 110, and knowledge cache 112 that are executed and controlled by one or more processors of server computing device 106. In some embodiments, information retrieval application 108, dialog control flow module 110, and knowledge cache 112 are specialized sets of computer software instructions programmed onto one or more dedicated processors in computing device 106.

As can be appreciated, in some embodiments information retrieval application 108 comprises a conversation service software application (i.e., virtual assistant (VA), chatbot) configured to automatically interact with a user at client computing device 102 in order to gather information and/or respond to inquiries. An exemplary conversation service application can be based upon a natural language processing (NLP) architecture using one or more NLP services 114a-114n which intelligently parse text messages received from remote computing devices to understand the context of the message(s) (also called the intent) and how to best respond to it. In some embodiments, information retrieval application 108 can establish a chat-based communication session with client computing device 102 to enable the user at client computing device 102 to participate in an automated chat session with information retrieval application 108. In these embodiments, information retrieval application 108 provides the chat interface for the exchange of messages with client computing device 102. In some embodiments, information retrieval application 108 comprises an intelligent search interface that receives input from the user of client computing device 102 (e.g., typed text or spoken phrases) and generates search results upon interpreting the user input. For example, the intelligent search interface can utilize one or more NLP services 114a-114n to determine user intent and then utilize one or more LLM services 116a-116n to generate a response to the user input. It should be appreciated that other types of information retrieval applications can be contemplated as within the scope of the technology described herein.

In some embodiments, client computing device 102 includes an application that executes on client computing device 102 to provide certain functionality to a user of remote computing device. In some embodiments, client computing device 102 can include a native application installed locally on remote computing device 102. For example, a native application is a software application (also called an ‘app’) that written with programmatic code designed to interact with an operating system that is native to client computing device 102 and provide information and application functionality (such as a chatbot interface) to a user of client computing device 102. In the example where client computing device 102 is a mobile device such as a smartphone, the native application software is available for download from, e.g., the Apple® App Store or the Google® Play Store. In some embodiments, the native application includes a software development kit (SDK) module that is executed by a processor of client computing device 102. In other embodiments, client computing device 102 can include a browser application that runs on the client computing device 102 and connects to one or more other computing devices (e.g., server computing device 106) for retrieval and display of information and application functionality (such as conducting a communication session with information retrieval application 108). In one example, the browser application enables client computing device 102 to communicate via HTTP or HTTPS with server computing device 106 (e.g., via a URL) to receive website-related content, including one or more webpages, for rendering in the browser application and presentation on a display device coupled to client computing device 102. Exemplary browser application software includes, but is not limited to, Firefox™, Chrome™, Safari™, and other similar software. The one or more webpages can comprise visual and audio content for display to and interaction with a user.

Dialog control flow module 110 comprises a specialized hardware and/or software module which executes on one or more processors of server computing device 106 for the purpose of dynamically controlling a dialog flow of the message exchange between client computing device 102 and information retrieval application 108. Generally, and without limitation, dialog control flow module 110 comprises programmatic instructions for a plurality of conversation dialog control functions that can be executed by server computing device 106 to manage and adapt a dialog flow between client computing device 102 and information retrieval application 108 during a communication session (e.g., chat, search flow, etc.). For example, information retrieval application 108 can be configured to follow one or more dialog workflows that include one or more events (e.g., utterance classification, intent determination, response generation, data capture, data retrieval, data prefill) to collect input from client computing device 102 and/or the user of device 102, from knowledge cache 112, from NLP services 114, from LLM services 116, and/or from data providers 118 used to generate responses to user utterances. Exemplary dialog control functions include but are not limited to:

Executing data providers and collecting context data outside of a dialog intent;

Storing values to a conversation session outside of a dialog intent;

Branching on conditions during a conversation session;

Invoking multiple NLP services and/or data providers in parallel;

Determining substitute intent to conditionally alter a conversation flow;

Executing specific bots and/or dialog flows based on context data collected during a conversation session; and

Eliminating the need to invoke a data provider when the data provider has previously been invoked in the conversation session.

Example pseudocode and descriptions for representative dialog control functions implemented in dialog control flow module 110 are provided in Appendix A to the specification.

Knowledge cache 112 comprises a memory location on server computing device 106 (or in some embodiments, one or more other computing devices coupled to the server computing device 106). Knowledge cache 112 is configured to receive, generate, and store specific segments of data relating to the process of establishing and conducting chat-based communications sessions including conversation-based and communication session-based data storage as described herein. Knowledge cache 112 provides a plurality of data storage slots for storage of certain types of data. As can be appreciated, system 100 can include one or more than one knowledge cache 112, each having data storage slots. In some embodiments, knowledge cache 112 is configured as part of an object resident in the information retrieval application 108 of server computing device 106 that manages the chat session with client computing device 102. In some embodiments, information retrieval application 108 can include a state cache with one or more objects that are used by application 108 for particular states. In some embodiments, knowledge cache 112 is allocated as part of the state cache so that it can be accessed from the state cache—for example, if the chatbot state cache is an object ‘state.nlp.*’ knowledge cache 112 can be a particular location in the state cache, such as state.nlp.sessionSlots.*' and each slot in knowledge cache 112 can be a different sublocation based upon the identifier assigned to the slot, e.g. ‘state.nlp.sessionSlots.firstSlot’ and the like. In this way, information retrieval application 108 can beneficially use knowledge cache 112 in the state cache as a place to store arbitrary values used during the chat session but which may not be desirable to include in the normal storage locations. In addition, in some embodiments knowledge cache 112 can be commonly used across different information retrieval applications that may be utilized by server computing device 106.

Although information retrieval application 108, dialog control flow module 110, and knowledge cache 112 are shown in FIG. 1 as executing within the same server computing device 106, in some embodiments the functionality of information retrieval application 108, dialog control flow module 110, and knowledge cache 112 can be distributed among one or a plurality of other computing devices that are coupled to server computing device 106. As shown in FIG. 1, server computing device 106 enables information retrieval application 108, dialog control flow module 110, and knowledge cache 112 to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention.

NLP services 114a-114n (collectively, 114) each comprise a computing resource that is configured to analyze incoming user utterances (e.g., messages received from a user of client computing device 102 as part of a communication session with information retrieval application 108) and provide a determined intent associated with the user message(s). As can be appreciated, a main goal of many information retrieval applications is to carry out a dialog flow with a user of client computing device 102—including parsing incoming user utterances, process the utterances using one or more NLP services 114 to understand the user's input, and determine a user intent for the utterances. Then, based upon the determined user intent, the virtual assistant can formulate a response to the user utterances (e.g., provides information, answers a question, initiates a transaction, etc.) that satisfies the user intent and continues the dialog flow. In some embodiments, NLP services 114 are domain—and/or context-specific according to an experience designed by an operator of server computing device 106. For example, an organization can design information retrieval application 108 and configure one or more NLP services 114 to comprehend particular utterances according to domain-specific knowledge or application functions.

In some embodiments, NLP services 114 can be application programming interfaces (APIs) that are called by information retrieval application 108 using one or more function calls including parameters such as the user utterances. It should be appreciated that NLP services 114 can be located on server computing device 106 and/or one or more computing devices that are separate from server computing device 106 (e.g., service endpoints, remote servers, and the like). Exemplary NLP services 114 include but are not limited to Google® Dialogflow™, Amazon® Lex™, and Microsoft® Azure Bot™.

Large language model (LLM) services 116a-116n (collectively, 116) each comprise a computing resource that is configured to analyze incoming data (also called a prompt) and generate a response to the prompt. In some embodiments, the incoming data can include but is not limited to user utterances, user intent, context data (e.g., information about the user of client computing device 102 obtained from device 102, data providers 118, and/or other sources), etc., typically in the form of one or more natural language sentences. Generally, each LLM service 116 is a machine learning model pre-trained on a vast corpus of general knowledge to be able to perform a variety of NLP tasks that can provide meaningful responses to prompts covering a large spectrum of different subject areas. Typically, LLM services 116 utilize machine learning algorithms such as generative transformer models that receive input prompts in the form of natural language text and generate sophisticated responses that are similar to what a human might create. Exemplary LLM services 116 include, but are not limited to, GPT-3™, GPT-4™, and ChatGPT™ from OpenAI, Inc.; PaLM™ 2 from Google, Inc.; LLaMA™ from Meta, Inc.; and FLAN-T5™ from Hugging Face.

Data providers 118-118n (collectively, 118) each comprise a computing resource that is configured to receive requests for data from information retrieval application 108 and return data responsive to the requests. In some embodiments, data providers 118 comprise external data sources (e.g. databases, data feeds, API endpoints, etc.) that can be called by information retrieval application 108 either as part of an active dialog workflow during a chat session with client computing device 102, or upon establishing a connection to device 102, to retrieve data elements used in the chat session.

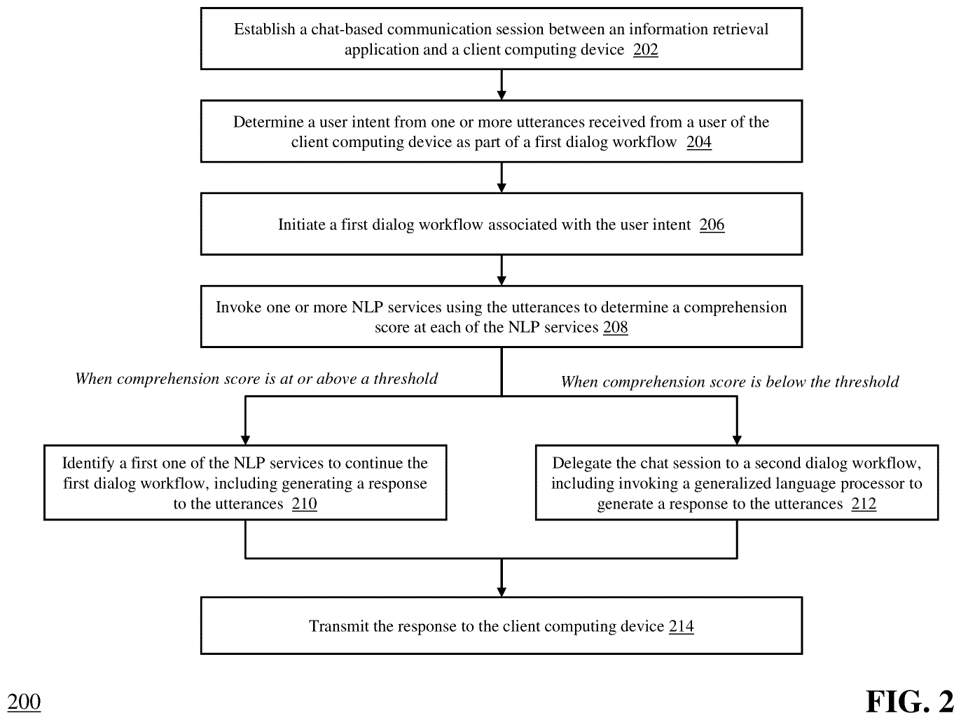

FIG. 2 is a flow diagram of a computerized method 200 of dialog control flow in information retrieval applications, using system 100 of FIG. 1. A user at client computing device 102 can launch an application (e.g., app, browser) to perform a variety of tasks, including but not limited to information retrieval from local and/or remote data sources. For example, when the application is a browser application, the user can interact with the application to access one or more websites and/or webpages (either internally or externally hosted) in order to view information and submit queries for retrieval of additional information. In one embodiment, the user of client computing device 102 is a customer accessing a company website to retrieve information (e.g., product information, account information, customer service information, and the like).

As can be appreciated, in some instances the information that the customer is seeking may not be readily available or the customer may have additional questions that he or she cannot resolve using only the information provided by the application. In these instances, the customer may want to conduct a chat-based communication session with server computing device 106 via information retrieval application 108. For example, a customer at client computing device 102 may want to connect to information retrieval application 108 for real-time, automated assistance in resolving a problem, performing a transaction, or answering a question. The customer at device 102 can launch an app or a browser to initiate a network connection (e.g., HTTP) to information retrieval application 108 on server computing device 106.

Server computing device 106 establishes (step 202) a chat-based communication session with client computing device 102 via information retrieval application 108. When the session is established, server computing device 106 can transmit one or more messages to client computing device that greet the user and ask the user how the information retrieval application 108 can help. The user at client computing device 102 can submit one or more utterances (e.g., chat messages) that relate to the purpose for initiating the chat-based communication session. In some embodiments, the user can type the chat messages into a user interface element on client computing device 102. In some embodiments, the user can speak one or more utterances that are converted from speech to text by client computing device 102 and transmitted to information retrieval application 108.

Information retrieval application 108 receives the utterances and determines (step 204) a user intent from one or more of the utterances. For example, information retrieval application 108 can invoke one or more machine learning classification models to classify the incoming utterances as belonging to a defined user intent. An utterance may have one or more words that the classification models are configured to detect and associate to a given intent. In some embodiments, the classification models can comprise neural networks, regression models, or other machine learning (ML) algorithms that are configured to predict intent associated with a given input utterance.

Dialog control flow module 110 initiates (step 206) a first dialog workflow associated with the user intent. As can be appreciated, a dialog workflow typically corresponds to a state-based conversation flow between client computing device 102 and information retrieval application 108, where information retrieval application utilizes one or more resources (e.g., NLP services 114, LLM services 116, data providers 118) to parse the utterances and generate appropriate responses (e.g., retrieving and displaying information to the user, requesting further information from the user, executing transactions) as necessary. In some embodiments, the first dialog workflow is determined after information retrieval application 108 classifies the user intent using the one or more utterances. For example, information retrieval application 108 can invoke one or more machine learning classification models to classify the incoming utterances as belonging to a defined user intent. An utterance may have one or more words that the classification models are configured to detect and associate to a given intent—e.g., when a user provides an utterance of ‘I want to learn more about 529 savings plans,’ the classification model(s) can analyze the utterance, identify the keywords ‘529 savings plans,’ and associate the utterance with a defined user intent of ‘529 PLAN.’ Then, module 110 can use the defined intent to select a dialog workflow designed to respond to the intent.

In some embodiments, the first dialog workflow is determined upon establishing the connection to client computing device 102. For example, information retrieval application 108 can capture certain context information associated with device 102 and/or a user of device 102 and analyze the context information to determine a relevant dialog workflow to execute as part of the chat session. The first dialog workflow is used by dialog control flow module 110 to manage the conversation flow and coordinate with one or more resources (e.g., NLP services 114, LLM services 116, data providers 118) to determine user intent, generate responses to utterances, update the conversation state of the chat session, and otherwise progress through the first dialog workflow. In some embodiments, module 110 can delegate the chat session to one or more other dialog workflows based upon certain conditions that occur during the chat session.

Once the user intent is determined and the first dialog flow is initiated, dialog flow control module 110 invokes (step 208) one or more NLP services 114 using the utterances to determine a comprehension score at each of the NLP services 114. In some embodiments, module 110 invokes each NLP service 114 to identify which service(s) 114 are able to comprehend the utterances and generate a relevant response. Generally, in this context, comprehension refers to the result when an NLP service can understand the utterance sufficiently to generate a suitable response and incomprehension refers to the result when an NLP service cannot understand the utterance and therefore cannot generate a suitable response. For example, module 110 can provide the utterances to one or more NLP services as input and, based on the responses received from the NLP services, determine whether each NLP service can comprehend the utterances or not comprehend the utterances. In some embodiments, the invoked NLP services 114 can return a dialog state parameter that is a binary value (numeric or alphanumeric) indicating whether comprehension is successful—such as nlp.dialogState=(“Incomprehension”|“Comprehension”). Module 110 can compare the comprehension score returned from each NLP service to a threshold value in order to determine whether the NLP service comprehends the utterances. In some embodiments, the invoked NLP services 114 can return a numeric value corresponding to a confidence level of the NLP service in comprehending the utterances. For example, an NLP service that returns a high confidence level can indicate that the NLP service may return a more pertinent or accurate response to the utterances than an NLP service that has a lower confidence level.

In circumstances where comprehension by one or more NLP services 114 is successful, dialog control flow module 110 identifies (step 210) a first one of the NLP services 114 to continue the first dialog workflow. For example, module 110 can determine that only one of the NLP services (i.e., service 114a) comprehends the utterances. As a result, module 110 identifies NLP service 114a to continue the first dialog workflow. Information retrieval application 108 retrieves a response generated by NLP service 114a to the utterances and transmits (step 214) the generated response to client computing device 102 as part of the chat session. Information retrieval application 108 also coordinates with dialog flow control module 110 to update the conversation state of the first dialog workflow according to the generated response, so that the dialog workflow can proceed to the next state and continue the conversation (e.g., receive additional utterances from client computing device 102 and generate responses).

In circumstances where comprehension by NLP services 114 is unsuccessful, dialog control flow module 110 delegates (step 212) the chat-based communication session to a second dialog workflow. For example, information retrieval application 108 may be able to determine a user intent from the utterances, but the construction of the utterances is such that none of the NLP services 114 is able to comprehend the utterances and generate an appropriate response. As a result, dialog control flow module 110 can identify a second dialog workflow that is associated with one or more generalized language processing services (i.e., LLM services 116). Module 110 can generate a prompt for input to one or more LLM services 116 using, e.g., the utterances, the user intent, and/or other context data associated with the client computing device 102, the user of device 102, and/or the chat session. Module 110 can then provide the prompt to LLM services 116 for generation of a natural language response to the utterances. For example, a user may provide an utterance of “pros/cons of high risk investment strategy.” Information retrieval application 108 can map the utterance to a user intent of “INVESTMENT,” but none of the NLP services 114 may be able to understand the utterance in order to generate a response. Module 110 can delegate the chat session to a second dialog workflow associated with one or more of the LLM services 116 that are configured to comprehend a wide variety of user inputs and to provide more generalized information to the user. It should be appreciated that, in some embodiments, dialog control flow module 110 can delegate the chat-based communication session to another resource apart from a second control workflow, such as another computing device or service that is configured to continue the conversation with the end user.

Module 110 generates a prompt for use as input to one or more LLM services 116. In some embodiments, module 110 can convert one or more data elements—such as the utterance, the determined user intent, and/or known attributes of the user—into natural language text. Module 110 can retrieve user attributes from knowledge cache 112 and/or one or more data providers 118 (e.g., demographics, account balances, chat context information, historical interactions, etc.) for use in generating the prompt. In addition, in some embodiments module 110 can retrieve one or more data elements associated with a conversation history (e.g., a prior exchange of messages with the user at client computing device 102, either in the current communication session or in prior communication sessions) and use the conversation history as input. Continuing with the above example, module 110 can determine that the user is a high-net-worth individual that has investments in both equities and bonds. Module 110 generates a corresponding prompt for LLM services 116, e.g., “Design multiple high-risk investment strategies that incorporate equity and bond assets and provide the benefits and drawbacks for each.” Module 110 provides the prompt to one or more LLM services 116. Information retrieval application 108 retrieves a response generated by LLM service 116a to the prompt and transmits (step 214) the generated response to client computing device 102 as part of the chat session. Information retrieval application 108 also coordinates with dialog flow control module 110 to update the conversation state of the second dialog workflow according to the generated response, so that the dialog workflow can proceed to the next state and continue the conversation (e.g., receive additional utterances from client computing device 102 and generate responses).

In some embodiments, dialog control flow module 110 is configured with retrieval augmented generation (RAG), which enables module 110 to identify relevant data from one or more data sources and integrate the relevant data with the LLM service 116 being invoked during the conversation workflow. Generally, RAG consists of two primary elements: (i) Indexing, which involves collecting and organizing data from various sources, typically performed offline, and (ii) Retrieval and generation, the core RAG process that, upon receiving a user's query in real-time, fetches pertinent data from the indexed information and integrates the fetched data with the LLM model for generation of a response.

Using RAG, dialog control flow module 110 begins by interpreting a user's question (as described above), then module 110 searches one or more data sources (including but not limited to data providers 118) to find relevant information. Module 110 selects the most applicable data and integrates the selected data with an input prompt for the LLM service 116. LLM service 116 receives the augmented input data and generates a response enriched with the external knowledge. This approach is especially beneficial for question-answering platforms that require up-to-date and accurate facts, ensuring that responses are not only credible but also factually correct.

Generally, the RAG workflow can be described in the following steps:
1. Query Interpretation: module 110 deciphers a user's query and determines if additional information is needed.
2. Dynamic Data Retrieval: Functioning like an agile search engine, module 110 searches a comprehensive knowledge base for information that is pertinent and recent in relation to the user's question.
3. Contextual Synthesis: Module 110 then merges the retrieved data with the input prompt for the invoked LLM service 116. In some embodiments, module 110 is configured to merge the retrieved data with the LLM service's existing knowledge base, enabling a more sophisticated grasp of the subject matter.
4. Informed Response Generation: With the latest information at hand, LLM service 116 formulates a response that is not just pertinent but also incorporates the most current insights and data.

As can be appreciated, RAG provides several important technical benefits to the use of LLM services 116 in generating a response during a conversation workflow, such as:
Current Information: RAG updates the language model's responses with the most recent data, enhancing their precision and trustworthiness.
Query-Specific Relevance: RAG tailors its information retrieval to the user's specific question, ensuring highly pertinent responses.
Boosted Creativity: Leveraging a wider knowledge base, LLMs are capable of producing more inventive and intricate content.
Data Integration and Contextual Understanding: RAG goes beyond listing data; it interprets and contextualizes information to grasp the nuances and interrelations.
Superior Response Formulation: Equipped with both internal knowledge and externally sourced data, the language model is able to formulate responses that are both extensive and accurate.

In addition, RAG can be leveraged in a number of specific applications, including the following examples:

1. Introducing new products/services: when a company unveils a new product or service, customers often seek immediate assistance to navigate the new features, typically preferring the promptness of a chatbot over the wait times for a human agent. Given the novelty of the product or service, customers may require guidance even for straightforward queries, which can be readily addressed using an existing knowledge base. However, because customers are asking about a new offering, existing NLP services 114, LLM services 116, and data providers 118 have no prior training on such data due to the absence of historical conversational records and existing knowledge-based training datasets are insufficient. Waiting to accumulate such data to train the language model is not a viable solution. Instead, integrating RAG into the dialog control flow module 110 allows for supplementation of LLM services 116 functionality with information about the new offering, enabling the services 116 and the module 110 to provide accurate responses to the end users.

2. Changes in existing policies/rules/details: if a company updates policies, rules, or details of an existing product or service, LLM services 116 trained on outdated data would provide incorrect responses. Until the services 116 are trained with updated information, dialog control flow module 110 can utilize RAG to enhance existing LLM services 116 by incorporating the latest changes, ensuring the generation of accurate responses.

3. New policies/rules/details introduced in existing product/service: when an existing product or service undergoes updates in policies, rules, or details, referencing the current information becomes essential. In such scenarios, RAG is instrumental in resolving customer queries because dialog control flow module 110 is able to integrate new updates from a knowledge base into the response generation process of the pre-trained LLM services 116, ensuring that customers receive accurate and up-to-date information.

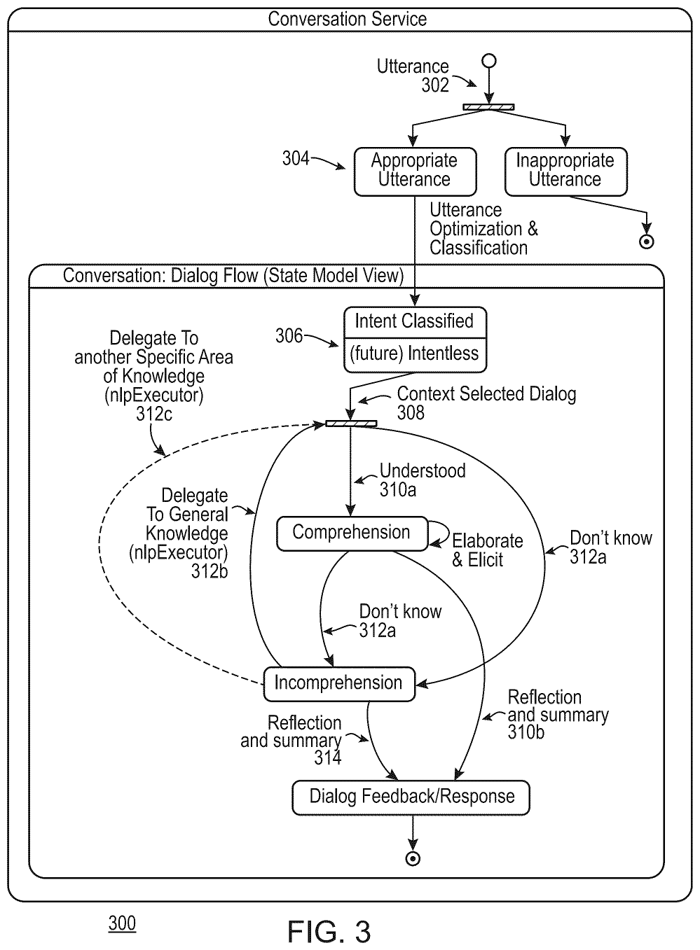

FIG. 3 is a diagram of an exemplary state model view 300 for dialog control flow module 110 of server computing device 106. As shown in FIG. 3, an utterance is received (302) from a user of client computing device 106 and information retrieval application 108 determines whether the utterance is appropriate or not (304). If appropriate, information retrieval application 108 optimizes and classifies the utterance according to user intent (306) and selects (308) a dialog flow for initiation.

Dialog control flow module 110 invokes an NLP service using the utterance and dialog flow to determine whether the NLP service comprehends the utterances. If the utterance is comprehended (310a), module 110 and information retrieval application 108 continue with the selected dialog flow to provide feedback/response(s) (310b) to client computing device 102. If during the dialog flow an utterance is not comprehended (312a), module 110 delegates the chat session to another resource (e.g., in a second dialog flow) to determine comprehension and generate a response to the utterance. For example, module 110 can delegate (312b) to a general knowledge resource (i.e., LLM services 116) and/or delegate (312c) to another NLP service 114 for determination of comprehension (310a) and response generation (310b). In some embodiments, if a suitable resource cannot be determined to comprehend the utterance, module 110 can generate a corresponding response (314) to client computing device 102 (such as asking for additional context, asking the user to restate the utterance, etc.).

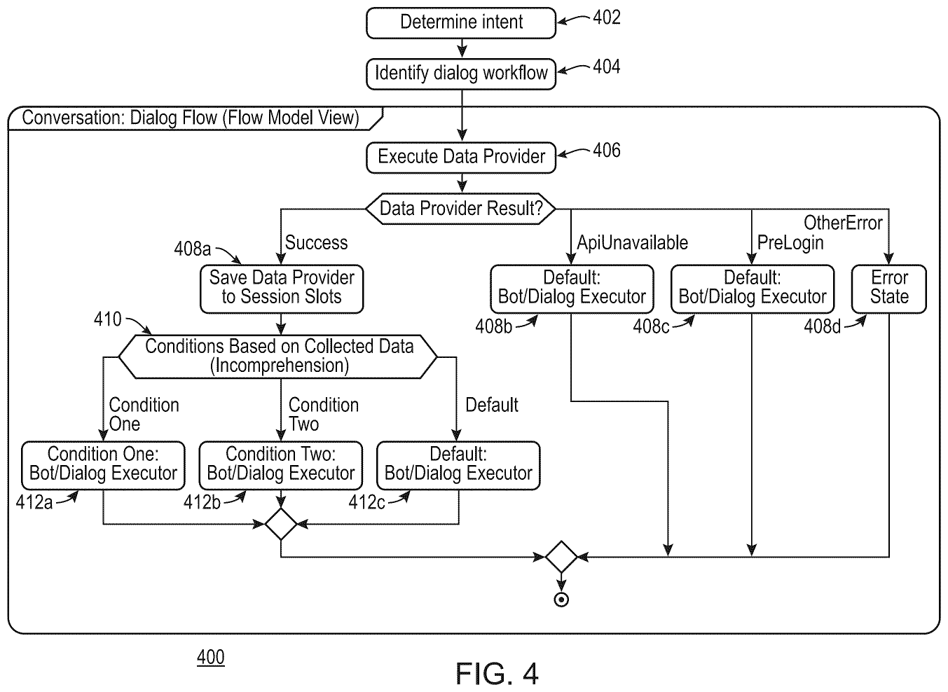

FIG. 4 is a diagram of an exemplary workflow 400 for dialog branching by dialog control flow module 110 of server computing device 106. As can be appreciated, module 110 has the ability to use conditions and branching during a dialog workflow, as well as the ability to make calls to data providers 118 and save data to, e.g., knowledge cache 112 during a conversation session. As shown in FIG. 4, information retrieval application 108 determines an intent (402) for an input utterance and dialog control flow module 110 identifies (404) a dialog workflow associated with the intent.

Dialog control flow module 110 initiates the dialog workflow and executes (406) a data provider 118a to, e.g., retrieve information to be used as part of the dialog flow. Based upon the result returned by data provider 118a, module 110 can branch the dialog flow to a plurality of different actions. For instance, a data provider may have multiple results that can be caught such as Success (408a), ApiUnavailable (408b), PreLogin (408c), or DataProviderError (408d).

If data provider 118a successfully returns data, module 110 can save the returned data to knowledge cache 112 (e.g., in one or more session slots) and determine (410) which service 114/116 to invoke based upon the collected data and the comprehension/incomprehension of the utterance. For example, module 110 can evaluate a plurality of conditions using the collected data and comprehension result (e.g., Condition One 412a, Condition Two 412b, Default Condition 412c) and based upon the evaluation, continue the dialog workflow to a specific service 114/116 according to the conditions.

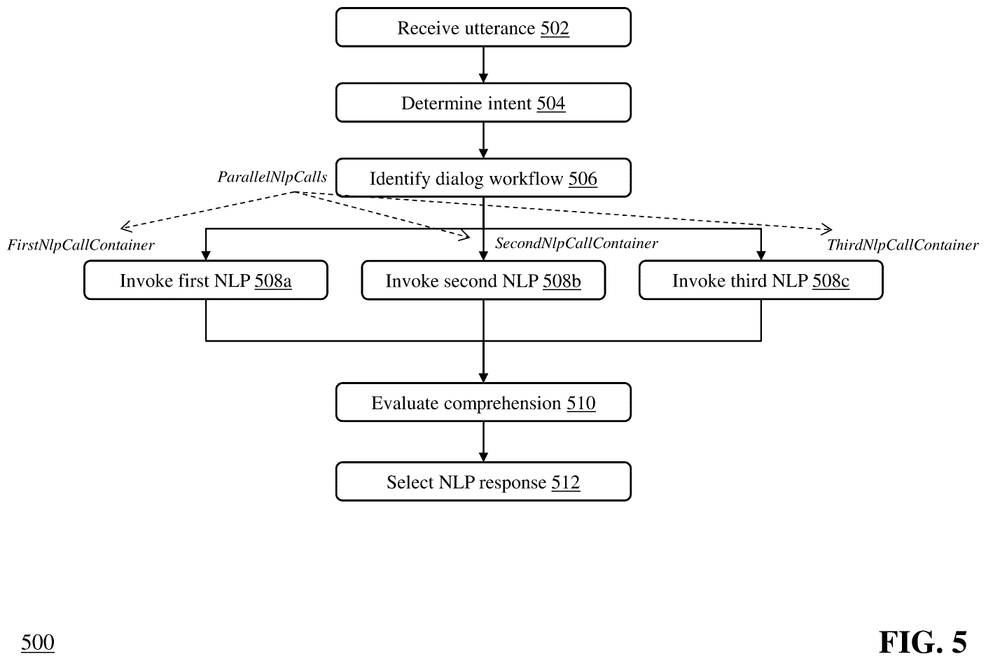

Another important technical feature of the systems and methods described herein is the ability of dialog control flow module 110 to execute states in parallel-which can be helpful when multiple NLP services 114 need to compete to give a response, multiple LLM services 116 need to be invoked to determine the most appropriate response, or multiple data providers 118 need to be executed in parallel for performance reasons. FIG. 5 is a diagram of an exemplary workflow 500 for execution of multiple parallel states by dialog control flow module 110 of server computing device 106. As shown in FIG. 5, an utterance is received (502) from a user of client computing device 106. Information retrieval application 108 determines an intent (504) for an input utterance and dialog control flow module 110 identifies (506) a dialog workflow associated with the intent.

Dialog control flow module 110 invokes a plurality of NLP services 116a-116c (508a-508c) using the utterance and dialog flow to determine whether any or all of the NLP services 116a-116c comprehends the utterance. As shown in FIG. 5, three NLP services 116a-116c are in competition with each other. Module 110 calls a conversation flow state (“ParallelNlpCalls”) which has three substates (FirstNlpCallContainer, SecondNlpCallContainer and ThirdNlpCallContainer). Each of these substates are executed and (in this particular case) are in competition with each other. Once module 110 executes all of the NLP services 116a-116c, module 110 evaluates (510) a condition for comprehension. In one example, the first NLP to satisfy the condition ‘wins’ and module 110 selects (512) its output for use in continuing the conversation workflow.

Another use of parallel scenarios is when module 110 executes multiple data providers 118 at the same time. In this particular case, the output of each data provider 118 may be needed to proceed with the conversation workflow. Module 110 can use a mapping function (mapping output from each child state to its parent)—rather than the ‘winner takes all’ scenario described above in FIG. 5.

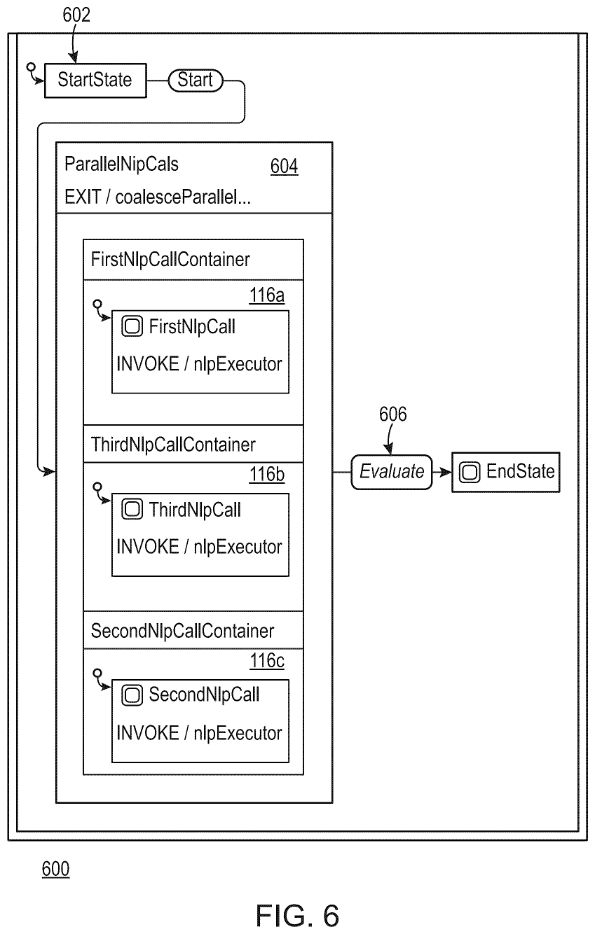

In another example, parallel scenarios can be used when NLP services 116a-116n are arranged in a ranked fashion, where a response from one NLP service is the most preferred or optimal, and responses from other NLP services are ranked below that. Instead of calling each NLP service one at a time according to the ranking, dialog control flow module 110 can call the NLP services in parallel (to improve response time) and choose the highest-ranking NLP service that is able to provide a response. FIG. 6 is a diagram of another exemplary workflow 600 for execution of multiple parallel states by dialog control flow module 110 of server computing device 106. From a start state 602, dialog control flow module 110 calls three NLP services 116a-116c concurrently. Module 110 calls a conversation flow state 604 (“ParallelNlpCalls”) which has three substates (FirstNlpCallContainer, SecondNlpCallContainer and ThirdNlpCallContainer) each associated with an NLP service 116a-116c. Each of these substates are executed and (in this particular case) are ranked according to preference of response: 1) FirstNlpCallContainer; 2) ThirdNlpCallContainer; and 3) SecondNlpCallContainer. Once module 110 executes all of the NLP services 116a-116c, module 110 evaluates (606) a condition for comprehension. In an example, if the FirstNlpCallContainer service 116a returns a comprehensible response, module 110 selects its output for use in continuing the conversation workflow because the service 116a is designated as the most preferred service according to the ranking. Alternatively, if FirstNlpCallContainer service 116a is unable to return a valid response, module 110 moves down the ranking and evaluates the output from the ThirdNlpCallContainer service 116b. If that service 116b returns a comprehensible response, the output is selected for continuing the workflow. Accordingly, i if neither FirstNlpCallContainer or ThirdNlpCallContainer returns a comprehensible response, module 110 selects the output from SecondNlpCallContainer for continuing the workflow.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer system for dialog control flow in information retrieval software applications, the system comprising a server computing device having a memory that stores computer-executable instructions and a processor that executes the computer-executable instructions to:
establish a chat-based communication session between an information retrieval software application of the server computing device and a client computing device;
determine a user intent from one or more utterances received from a user of the client computing device during the chat-based communication session;
initiate a first dialog workflow associated with the user intent;
invoke one or more natural language processing (NLP) services using the one or more utterances as input to determine a comprehension score for the user intent at each of the one or more NLP services;
identify a first one of the NLP services to continue the first dialog workflow when the comprehension score for the identified NLP service is at or above a threshold value, including generating a response to the one or more utterances using the first NLP service;
delegate the chat-based communication session to a second dialog workflow when the comprehension score for each of the NLP services is below the threshold value, including invoking a generalized language processing service associated with the second dialog workflow using the user intent as input to generate a response to the one or more utterances; and
transmit the generated response to the client computing device as part of the chat-based communication session.

2. The system of claim 1, wherein determining the user intent from one or more utterances comprises invoking one or more machine learning classification models using the one or more utterances as input to classify the one or more utterances as belonging to a defined user intent.

3. The system of claim 2, wherein invoking one or more machine learning classification models using the one or more utterances as input comprises analyzing each of the one or more utterances, identifying one or more keywords in each utterance, and classifying each utterance as belonging to a defined user intent based upon the identified keywords for the utterance.

4. The system of claim 1, wherein the server computing device captures context information associated with one or more of the client computing device or the user of the client computing device when establishing the chat-based communication session.

5. The system of claim 4, wherein initiating the first dialog workflow associated with the user intent comprises analyzing the context information in conjunction with the user intent to identify the first dialog workflow.

6. The system of claim 1, wherein the generalized language processing service associated with the second dialog workflow comprises a large language model (LLM) service.

7. The system of claim 6, wherein invoking the generalized language processing service associated with the second dialog workflow comprises:
generating an input prompt for the LLM service based on the user intent;
augmenting the input prompt using information from one or more external data providers; and
invoking the LLM service using the augmented input prompt as input to cause the LLM service to generate the response to the one or more utterances.

8. The system of claim 1, wherein the information retrieval software application comprises a conversation service application or a virtual assistant application.

9. A computerized method of dialog control flow in information retrieval software applications, the method comprising:
establishing, by a server computing device, a chat-based communication session between an information retrieval software application of the server computing device and a client computing device;
determining, by the server computing device, a user intent from one or more utterances received from a user of the client computing device during the chat-based communication session;
initiating, by the server computing device, a first dialog workflow associated with the user intent;
invoking, by the server computing device, one or more natural language processing (NLP) services using the one or more utterances as input to determine a comprehension score for the user intent at each of the one or more NLP services;
identifying, by the server computing device, a first one of the NLP services to continue the first dialog workflow when the comprehension score for the identified NLP service is at or above a threshold value, including generating a response to the one or more utterances using the first NLP service;
delegating, by the server computing device, the chat-based communication session to a second dialog workflow when the comprehension score for each of the NLP services is below the threshold value, including invoking a generalized language processing service associated with the second dialog workflow using the user intent as input to generate a response to the one or more utterances; and
transmitting, by the server computing device, the generated response to the client computing device as part of the chat-based communication session.

10. The method of claim 9, wherein determining the user intent from one or more utterances comprises invoking one or more machine learning classification models using the one or more utterances as input to classify the one or more utterances as belonging to a defined user intent.

11. The method of claim 10, wherein invoking one or more machine learning classification models using the one or more utterances as input comprises analyzing each of the one or more utterances, identifying one or more keywords in each utterance, and classifying each utterance as belonging to a defined user intent based upon the identified keywords for the utterance.

12. The method of claim 9, further comprising capturing, by the server computing device, context information associated with one or more of the client computing device or the user of the client computing device when establishing the chat-based communication session.

13. The method of claim 12, wherein initiating the first dialog workflow associated with the user intent comprises analyzing the context information in conjunction with the user intent to identify the first dialog workflow.

14. The method of claim 9, wherein the generalized language processing service associated with the second dialog workflow comprises a large language model (LLM) service.

15. The method of claim 14, wherein invoking the generalized language processing service associated with the second dialog workflow comprises:
generating an input prompt for the LLM service based on the user intent;
augmenting the input prompt using information from one or more external data providers; and
invoking the LLM service using the augmented input prompt as input to cause the LLM service to generate the response to the one or more utterances.

16. The method of claim 9, wherein the information retrieval software application comprises a conversation service application or a virtual assistant application.
